(19) United States
(12) Patent Application Publication
(10) Pub. No.: US 2015/0242812 A1
(43) Pub. Date: Aug. 27, 2015

(54) Device and system for implementing advance directives

(71) Applicants: William Bert Nelson, Excelsior, MN (US); Glenn Albert Nickele, Forest Lake, MN (US); Robert Sigurd Nelson, La Mesa, CA (US)

(72) Inventors: William Bert Nelson, Excelsior, MN (US); Glenn Albert Nickele, Forest Lake, MN (US); Robert Sigurd Nelson, La Mesa, CA (US)

(21) Appl. No.: 13/999,449

(22) Filed: Feb. 26, 2014

(51) Int. Cl. G06Q 10/10; G06Q 50/18; G06Q 50/22

(52) U.S. Cl. CPC G06Q 10/10; G06Q 50/22; G06Q 50/18

(57) ABSTRACT

The invention provides a system for effectively implementing a patient's specific wishes (advance directives) regarding medical care even in a setting where the patient is incapacitated or is unable to communicate directly with care providers. In one implementation an Advance Directives portable combined identification unit device or equivalent device is employed to register and access a patient's wishes concerning limitations on health care measures to be applied when the patient is unresponsive. The patient's Advance Directives and identification material such as biometric information may be stored on a server (including the Cloud) or on a Personal Data Containment System device such as a RFID-enabled chip, a flash drive, a phone Application, etc. The Advance Directives information can be accessed by an automated code robot device which may result in alterations to protocol-driven medical procedures such as CPR and defibrillation.

This is a continuation of the provisional application No. 61/851,121 filed on Mar. 4, 2013.

### FIELD OF THE INVENTION

This disclosure relates to a system for effectively implementing a patient's specific wishes (advance directives) regarding medical care even in a setting where the patient is incapacitated or is unable to communicate directly with care providers.

### BACKGROUND OF THE INVENTION

When urgent or emergent medical care is provided, often the patient is unable to express any special provisions they have regarding the type of care they wish to receive. Barriers to communication are often due to unconsciousness, altered consciousness, language barriers, neurological impairment or other impediments to expression. In addition, family members may not be readily available and even if available may not be aware of an individual's wishes. Documents expressing a potential patient's wishes, even if they exist, are not usually readily available. First responders outside a hospital setting and care providers in the emergency room default to providing all aggressive measures available in patients except those in whom there is no short term chance of survival. As a result, it is not uncommon for patients to receive care they did not desire and even be kept alive with mechanical support or procedures that they did not wish to have. This can cause unnecessary suffering of patients or family members. In some circumstances, patients or families may be anguished by these issues which may even violate their religious beliefs (e.g., blood transfusions). Alternatively, medications or interventions indicated for a pre-existing condition may be withheld if the condition is not readily known. Only if and when the appropriate documents or knowledgeable family members are located can the care providers know the wishes of those who are unable to express their wishes themselves. The current system of communicating one's care preferences (conventional advance directives and power of attorneys) does not adequately meet the needs of unresponsive or otherwise incapacitated patients presenting with emergent medical problems, nor does the system allow health care providers in these situations to best meet the patient's wishes.

### SUMMARY OF THE INVENTION

The invention utilizes developments in identification software and hardware as well as the ability to access in real time or near-real time electronic information networks/databases to implement a nearly instantaneous medical information system that will allow first responders and health care providers to treat the unresponsive or incapacitated patient in the manner most consistent with their wishes. Additional benefits may include a substantial reduction in over-utilization of health care resources and therefore a reduction in health care costs. This invention describes a device and system that can be employed in order to insure that the health care measures performed on an incapacitated individual are consistent with those measures that the patient has agreed to accept and that the patient will not be subjected to those measures that they do not wish to have performed. The system (Advance Directives system) will be comprised of a portable identification module (device) that will be electronically linked (via wired or wireless communications such as WIFI, cellular network, etc.) with a computerized local, regional or nationwide (or international) data base. In one implementation, the portable identification module can be electronically linked locally to an information display workstation (e.g., at the desk of an emergency room or in the back of an ambulance). In another implementation, the portable identification module and the information display component can be integrated into a single combined identification unit (CIU). The CIU consists of a portable/handheld device that includes one or more biometric identification devices such as a camera for face recognition and profiling (with optional video capability or a separate camera for video), a biometric reader, chemical sensors, a microphone for voice recognition, EKG recorder, etc., an optional electronic marker identification device such as an RFID reader, a badge scanner or imager, etc. as well as a display screen for visual automated instructions and a speaker for verbal instructions. An input keyboard (virtual or keypad) will also be featured. The CIU module will have a docking unit which permits at least one of interfacing with other devices and charging its power source when it is not in use. Additional means of electronic communication can be readily implemented such as wireless and wired (e.g. USB port) devices. A power cord will also be available to allow the device to be charged by plugging it into a nearby outlet. Visual information can also be linked into a wearable device such as a helmet with a heads-up display, smart glasses (one example being GOOGLE glasses) and special contact lenses.

In one implementation that does not employ the CIU, a fixed or portable information display workstation will be utilized and will consist of computer, monitor and keyboard. The display workstation may be a station dedicated to this system or a multipurpose computer which contains a desktop application (app) of the system. In one implementation of the invention at least one identification device such as a biometric identification device (for example, a camera for face recognition and physical profiling with optional video capability or a separate camera for video), a biometric reader, chemical sensors, a microphone for voice recognition, an EKG recorder, etc., an electronic marker identification device such as an RFID reader, a badge scanner or imager, etc. along with a display screen for visual automated instructions and a speaker for verbal instructions are incorporated into or connected to the information display workstation. In the implementation of the invention wherein the work station is combined with the identification module, duplicate identification/biometric devices can be omitted.

The ability for users to input data and access information can be augmented as needed by implementing a larger, more intricate display monitor and input keyboard or virtual keyboard as well as an improved microphone for voice command recognition. Use of either the identification module or the information work station will be permitted once the user has been identified using one or more of the following methods including, but not limited to, facial recognition, voice recognition, other means of biometric identification, password entry, etc. in order to maintain medical information confidentiality and to insure the ability to track users who accesses any patient's records. An authorized user database will therefore be kept. Once granted access to the identification module and information workstation or the CIU, an authorized user will then be able to properly identify whether the patient being cared for is in the Advance Directives system database and access relevant information. In one implementation the identification module or CUI would be used to acquire a photograph of the patient (which could also include acquiring a profile of the patient) and then implement facial recognition software (and optionally, profile recognition software) to find a match in the database. Additional or alternative identification methods and/or verification options include, but are not limited to, other biometrics (fingerprints, palm, iris, voice, EKG, etc.), scanning for a RFID chip, scanning a barcode or a magnetic strip or using a tag reader on registration card carried by patients in order to identify themselves as participating in the database. In addition, the patient name can be accessed from an ID card or from a family member. Any of these steps will produce a patient demographic screen on the display which includes appropriate photos and profile information. (Alternatively, in the event a patient is not registered, the screen may display that the patient is not found in the database. In the case a patient is not in the database, facial recognition software could potentially then be used to scan social networking sites, government databases or other databases that can be either publically accessed or have granted access to this system to help identify the patient and facilitate contacting relatives or a power of attorney.) If a match is found, the authorized user will then be asked to verify that the picture and information matches the patient being cared for. Once this has been done, the patient's information regarding desired care measures, allergies, prior treatment, etc. will be displayed on the CIU (or identification module unit with the display workstation) to an authorized user. Care providers can then use this information to best treat the patient in the manner consistent with the patient's wishes.

A local, regional or national (or international) computerized server (which could be Cloud-based) will maintain a database of authorized users' and all patients that are registered. Databases for enrollees within a local geographic area may also be stored locally in encrypted form on a storage medium attached to or incorporated into a computer, tablet, phone, etc. This information will be accessed as needed by the above described identification and information display units. Authorized users can be added or removed to this database by healthcare facilities, fire departments, paramedic departments, clinics, etc. as needed. Patients who register with the system will complete an initial enrollment process in which demographic information is recorded, facial recognition, profile and additional biometric data are acquired, special medical care requests are input and initial entry of medical data is performed (e.g., allergies, chronic medical problems, etc.) Patients will also consent to allow participating authorized users and healthcare facilities to access this data as well as allowing those facilities to release records to the system so the information can be update and augmented as needed. A patient will be provided with either a personal user ID and password, a biometric identification or both which will permit the patient to access their profile in the future in order to alter specific treatment wishes or basic demographic data as needed. An authorized user will be allowed to make additional advance alterations to a patient's profile.

In one implementation of the Advance directives system the patient's biometric identifying data, advance directives, medical history, etc. can be carried by the patient in an encrypted form on his/her person (as well as being stored in a database) as a Personal Data Containment System device (PDCS). The PDCS comprises a portable, secure data storage unit which is accessible by physical (a reader, a scanner, a USB port, etc.) or wireless means, which contains the patient's advance directives and identifying biometric information and optionally can contain the patient's medical history as well as personal information (information concerning family members, friends, a will, etc.). The PDCS can be hand-held (an application that runs on a smart phone or iPAD or related device), wearable or stored in a wearable item such as a wallet, glasses, pants, etc., or embedded in the patient's body. This PDCS could be implemented utilizing a RFID-enabled chip, flash drive, barcode, tag, smart phone app, a tablet (an iPAD or related device) app, or another secure form. In the case of RFID-enabled chip, flash drive, etc., the information could be attached to a necklace, wristband, watch, ankle bracelet, ring, belt buckle, glasses, any other jewelry or clothing article, by a piercing, by an implant, by embedding under the skin, by printing on the skin. Additional options include incorporation into a driver's license, insurance card, Medicare or SS card, a passport or other accepted ID form. By having the patient carry the PDCS a patient identification tool can be programmed to read out the encrypted biometric identifying data held on the PDCS and match it to locally-obtained facial reading, fingerprinting, etc. and thus eliminate the need to access a remote database or conduct network/internet searches and thereby further expediting the patient's care. Once properly identified, the patient's records, directives, etc. can also be displayed directly from the locally-accessed data PDCS, bypassing the immediate need to access a network/internet (although if the network can be accessed then an analysis could be conducted to establish whether the PDCS information is up-to-date).

Additional encrypted data stored in the database on local or remote servers, various storage mediums or the PDCS may also include, but is not limited to, emergency contacts with contact information (to be informed via automated text, email, or phone call whenever enrollee receives emergency care). Also, automated emails can be sent to the enrollee or designated individuals whenever the enrollee's records are opened for any reason or changes made. An Enrollee may also store encrypted data that will only be accessible after their death. These may include automated emails or texts (visible only to recipient if so desired). The enrollee's wishes concerning burial or cremation preferences, organ donation preference, body donations to science, etc. may also be stored in the database.

When a person suffers a cardiac arrest the current standard of care is for a bystander to call 911 and to start manual chest compressions or CPR. If an automatic defibrillator (ICD) is available these are attached and will automatically attempt to defibrillate the patient if they are analyzed to be in ventricular fibrillation or ventricular tachycardia. When an ambulance or EMS arrives advanced life-support is started. This usually involves continuation of manual chest compressions/CPR and attachment of an ICD device (if AED was not applied). Sometimes manual CPR is stopped and a dedicated chest compression machine such as a Lucas is attached which has a plunger and does mechanical CPR. The paramedics analyze the heart rhythm and blood pressure, draw blood, obtain IV or IO access and make decisions on whether to defibrillate or give medications or IV fluids. In general they follow code sequences from American heart or American College of Cardiology guidelines. Intubation of the patient may also be performed, although it has not been shown to improve outcomes. Multiple times during a code sequence a paramedic or physician will make decisions about whether to defibrillate, continue CPR, or give medications, or IV fluids. Most of these decisions are based on whether or not the EKG monitor shows a shockable rhythm or a non-shockable rhythm such as possible pulse-less electrical activity (PEA) or asystole. In most instances that these procedures are carried out the paramedics or physicians are not aware of the patient's wishes and whether they want a prolonged code or resuscitation or whether they want a single shock, a limited code or nothing done. A code robot (CR) can be implemented that incorporates under computer control a large number of the functions that are currently done by (typically) multiple people during ACLS resuscitation or a code. The CR would combine and integrate all aspects of ACC or American heart guidelines for resuscitation. The CR software would implement advance directives as specified by the patient and communicated to the CR through a CIU or other approved communication means. In one implementation the functionality of the CIU (for purposes of patient identification and therefor access to advance directives) can be incorporated directly into the CR. This automated CR (with the ability to provide manual control for any or all functions when used by trained individuals) can be used by both trained medical personnel as well as untrained individuals.

In one implementation of the system, the CR could be employed to perform advance life support on critically ill patients. This CR could communicate with the advance directive system in a number of ways. A wired or wireless connection to the CIU could be supported to allow the CR to thereby communicate with the advance directives server/database. Thus, the CR could perform advance support which would be consistent with the wishes and desires of the patient. Manual override and operation of the CR would be an option. If patients lack available advance directives then the CR would perform advance cardiac life support protocol measures per current American Heart Association guidelines. The CR would be able to perform chest compression. In addition, the CR would contain in its housing at least one of a defibrillator, defibrillator pads, advance life support drugs, intravenous and intraosseous access equipment, tubing and patient monitoring devices such as end tidal CO₂ monitors, oxygen saturation monitors, automatic blood pressure cuff, etc.

### BRIEF DESCRIPTION OF THE DRAWINGS

FIG. 1 illustrates a perspective front view of a combined identification unit including identification, data input, audio, viewing and connections means.

FIG. 2 illustrates a perspective rear view of a combined identification unit including a camera and light source.

FIG. 3 illustrates a perspective end-on view of a code robot including an adjustable-height motorized chest compression plunger (CPR plunger), a display screen and outlets for replaceable single-use items.

FIG. 4 illustrates a perspective top view of a code robot in place on a patient.

FIG. 5A illustrates a perspective top view of the code robot including an access panel, cradles, control panels and adjustable control dials.

FIG. 5B illustrates a perspective side view of the code robot showing hinges.

FIG. 5C illustrates a perspective side view of the code robot showing a latch on the opposite side from the hinges.

FIG. 6 illustrates a perspective front view of the code robot in the open position showing an adjustable-height motorized chest compression plunger.

### DETAILED DESCRIPTION

The invention provides a device and system which allows a substantial improvement in the delivery of health care in a variety of urgent and emergent care settings. The proposed system is portable, permitting it to be taken to essentially any location that a first responder might be asked to deliver care. Various implementations of the device and system either require access to a communications network for data retrieval or are self-contained (storing data within the device or storing data locally on the enrollee's person using a PDCS) and can be deployed without access to a communications network. A basic implementation of the device and system enables near-instantaneous access to a patient's advance directives medical information including, but not limited to, the patient's desire for mechanical support (ventilator, etc.), blood transfusions, willingness to undergo invasive procedures, or surgeries, the use of defibrillators, the use of CPR, etc. as well as important contacts such as an insurance provider, relatives/friends, power of attorney. A more-comprehensive implementation of the system provides both the patient's advance directives and the patient's complete list of medical problems including active medications, allergies, recent ER/office visits and recent hospital stay records (diagnostic tests, discharge summaries, surgical reports, etc.). The patient may be given the option of merging his or her advance directives information directly into the patient's medical records.

All data entries and transmissions would be encrypted for confidentiality and any entries into patient records would be tracked by identifying and tracking all users that access the system. Only those registered as authorized users would be allowed access to the patient's information after identification. The availability of the medical records/documents, etc. as detailed above would allow immediate application of appropriate medical care at the time when emergent and urgent care is being provided. A significant benefit of this system is a reduction in the frequency with which patients are subjected to procedures, tests and intervention that they do not desire. A further benefit will be a reduction in the administration of inappropriate medications (e.g., due to allergies). Information on prior testing or procedures on a patient will reduce duplication of testing. Information on a patient's known medical conditions will expedite in diagnosing current medical conditions or identifying precipitating factors in their current condition. Each of these measures is expected to lead to a lower cost of care per patient and a substantial reduction in overall health care costs.

Patients that enroll in the system (the Advance Directives system) would have an initial registration session (as previously described) during which they would provide appropriate information concerning demographic data, relevant medical data and their advance directives. If the patients are enrolling in a more-detailed advance system then they will provide more-detailed information concerning their medical records (or grant access to their medical records) for data storage. One or more processes for identification of the patient would be employed including, but not limited to: 1. Face recognition and profiling. 2. Other biometrics such as finger, hand, palm, arm, retina, sub-dermal, EKG, etc. 3. Voice recognition. 4. Identification using a RFID badge or chip implant with information retrieval capability (including pacemakers, loop recorders, etc.). 5. Identification using bracelets, other jewelry, watches, glasses, etc. with information retrieval capability. This registration might be performed at a stand-alone facility maintained by a corporation or entity maintaining the database and coordinating the Advance Directives system. It might also be done at the patient's health care provider by an individual who has been authorized to enroll patients. Self-enrollment of individuals can also be accomplished by implementing an enrollment application (enrollment software) on a kiosk, an ATM, a private or an on-line vendor or government web site, a dedicated enrollment web page, a personal computer, a tablet/ipad, a smart phone/iphone, TV, etc. Self-enrollment capabilities could be implemented at store checkouts, recreational or sport facilities, government facilities (court houses, police stations, DMVs, libraries), etc. Employers might offer registration sessions for employees as a way to encourage participation. This might allow lower premium rates on employer-sponsored policies related to lower overall health care costs. Insurance companies may also enroll persons that hold individual policies, again as a way to contain costs and enable lower premium rates. Local, county, state and federal medical programs could also register patients. For example, Medicare enrollment would help to significantly reduce Medicare expenditures over time. The process of enrolling would encourage individuals to consider how they would want to be treated in the event of an emergency medical situation and provide advance directives, a step many people neglect. The enrollment process would allow individuals to understand their options and help to clarify any questions. Once enrolled, individuals would be able to alter information regarding care wishes by visiting an enrollment site such as at their health care provider, etc. Another option is to let the patient (the enrollee) make changes directly by using a personal secure login to their account (including using at least one of a user ID or password, facial recognition, profiling, other biometrics, voice recognition, etc.). Any entries into the system and any changes made would be tracked and monitored. Changes to health care wishes would be detected and an email or letter would be sent to the patient's preferred contact address to verify the change. A phone call could also be made to the patient. At enrollment, all patients would be encouraged to sign a release form to allow any subsequent medical records generated from future and past care encounters, tests, procedures be added to their medical information if deemed appropriate. In the event that a patient is chronically incapable of decision making, a power of attorney is often appointed for an individual. In these cases, the individual with power of attorney authority can set up the necessary database for a patient and consent for its use.

The biometric data and medical data entered into the database at the time of enrollment can also be stored in an encrypted form on a portable storage medium to be available to the enrollee to carry on his/her person. This could be done using a RFID chip or other wireless communication chip, a flash drive, a barcode, a tag, a smart phone app or another secure format. In the case of a RFID chip, flash drive, etc., the stored information could be attached to or embedded in a necklace, wristband, ankle bracelet, ring, belt buckle, piercing and other jewelry or clothing article. A RFID chip or other wireless communications chip could also be inserted underneath the skin. Alternatively, it might be incorporated into a driver's license, insurance card, Medicare or SS card, or an accepted ID form. This personal data containment system (PDCS) could be carried by the patient to provide another option for emergency personnel to quickly access patient biometric and care information. Information held in the PDCS can be compared with data stored on a server if there are issues related to which set of information is the most up-to-date.

In one implementation of the system, a CR can be employed to perform advance life support on critically ill patients. This CR could communicate with the advance directive system in a number of ways. A wired or wireless connection to the CIU could be supported to allow the CR to thereby communicate with the advance directives server/database. In this way the CR could perform advance support which would be consistent with the wishes and desires of the patient. Manual override and operation of the system would also be an available option. For patients without available advance directives, the CR would perform advance cardiac life support protocol measures per current American Heart Association guidelines. The CR would be able to perform chest compressions using an adjustable-height, motorized plunger (also referred to as the CPR plunger) to perform chest compressions. In addition, the CR would contain in its housing at least one of a defibrillator, defibrillator pads, advance life support drugs, intravenous and intraosseous access equipment, tubing and patient monitoring devices such as end tidal CO₂ monitors, oxygen saturation monitors, automatic blood pressure cuff, etc.

For a critically-ill patient the CR could be applied to the patient and the CPR plunger adjusted to the appropriate height. Responders could then activate the CR to begin CPR if no pulse were present. Responders could manually apply (or use a robot arm) defibrillation patches, insert IV or IO access and apply monitoring devices as appropriate. With each extra monitor or access applied, the responders would signal (via voice command, pushing a button on the CR control panel, using a remote control, an ipad application, etc.) which devices were in place and available for the CR to use. For example, when the IV or IO access option was activated, the CR could then inject the appropriate life support medications automatically when called for in the ACLS protocol (or withhold them if the patients advance directive so stated) Once the defibrillation pads were activated (automatically sensed by the CR), defibrillation shocks could be delivered at the appropriate times. Chest compression delivery could be manually or electronically suspended (under the control of a computer algorithm) at necessary intervals to identify if a pulse were present.

When a person suffers a cardiac arrest the current standard of care is for a bystander to call 911 and to start manual chest compressions or CPR. If an automatic ICD is available these are attached and will automatically attempt to defibrillate the patient if they are analyzed to be in ventricular fibrillation or ventricular tachycardia. When an ambulance or EMS arrives advanced life-support is started. This usually involves continuation of manual chest compressions/CPR and attachment of an ICD or another device (if AED was not applied). Sometimes manual CPR is stopped and a chest compression machine such as a Lucas is attached which has a plunger and does mechanical CPR (Woerlee has described one version of an automated CPR plunger, U.S Patent No. US20110092864 A1). The paramedics analyze the heart rhythm and blood pressure, draw blood, obtain IV or IO access and make decisions on whether to defibrillate or give medications or IV fluids. Intubation of the patient may also be performed, although it has not been shown to improve outcomes. Multiple times during a code sequence a paramedic or physician will make decisions about whether to defibrillate, continue CPR and give medications or IV fluids. Most of these decisions are based on whether or not the EKG monitoring shows a shockable rhythm or a non-shockable rhythm such as possible pulse-less electrical activity (PEA) or asystole. The majority of the time that these are carried out, the paramedics or physicians are not aware of the patient's wishes and whether they would want a prolonged code or resuscitation or whether the patient would only want one shock, a limited code or would want nothing done. In general follow code sequences from American heart or American College of Cardiology guidelines would be followed.

The CR incorporates a number of functions that are currently performed by one or multiple people during ACLS resuscitation or a code, permitting levels of automization not available with current devices such as the Lucas system that may require one or more medical personnel to implement and suffers from outcomes that vary due to the varying levels of proficiency of medical personnel in performing CPR, interpreting ECG tracings and medical data, and making decisions necessary to properly carry out advanced life support. For example, the delivery of medication/IVF through intraosseous means could be through the center of the CPR plunger on the chest with flexible tubing connecting to the sternum. Initially, the CR could drill or inject the intraosseous needle into the sternum. In addition, medication could also be delivered through the knee or a joint, the anterior tibia. The probe device that does this could be integrated into the CR or separate from the CR and communicate with the CR through a wireless (bluetooth, wifi) or a wired connection. The probe device could have a small drill that would drill into the bone or enter the joint space and be connected to a needle and bags of solutions, IVF, meds etc. The probe device may be connected by a robotic arm controlled by the CR or attached and operated manually. Once the needle is inserted the CR could utilize this access to automatically deliver medications or fluid or, alternatively to withdraw blood or fluids for monitoring of the patient. Manual control would be available at all times via direct or remote access to the CR. In addition, additional devices such as sensors could also be strapped around the wrist that would measure biologic activity such as HR/BP/temp/electrolytes/blood sugar, etc. which would be communicated to the CR. Thus, the CR, with the ability to control additional devices could be used to replace humans in many or all code situations, out of hospital or in hospital, since it may be more reliable than many medical personnel in delivering CPR, interpreting rhythms, delivering fluids and coordinating all the interventions that occur during a code. This could allow untrained people to operate the CR in environments such as schools, trains, planes, ships, social activities, etc. where the CR would provide step-by-step instructions to the untrained operator. In one implementation the CR could attach itself (its devices) to a person. In another implementation the CR issues verbal, written, video or holographic instructions to untrained bystanders who could attach the appropriate devices to the person suffering the cardiac arrest. Once devices are attached the CR would be able to provide all sequences of CPR, defibrillation, fluid resuscitation, ECG and rhythm monitoring and analysis of oxygen saturation, CO₂ saturation, blood electrolyte and chemical sampling, temperature, heart rate, blood pressure, etc. and follow algorithms to improve survival. The use of an automated CR allows the implementation of new features such as the incorporation of one or more ultrasound imaging devices (including ultrasound arrays) that could acquire echo images as well as other information during code. These echo images could be evaluated for pericardial effusion or other etiologies of code. Any and all of the above patient data could be used to alter a code sequence if warranted. The CR would be programmed to alter the code sequence automatically based on the data received.

The CR would be able to provide audio instructions to responders to insure proper application and use of the device. A video screen could show video instructions to assist responders in proper operation of the CR. 3D holographic projections might also be used to provide instruction. In addition to a control panel on the CR and a remote control, the CR might also be able to follow voice commands to suspend chest compressions, defibrillate, etc. Information of heart rhythm, heart rate, blood pressure and all other monitored processes would display in real time on a video monitor as the CR performed life support. This data could also be transmitted in real time to a local hospital, emergency room, code station or paramedic station. Medical personnel at these remote sites of at the scene of the CR could override the CR or give instructions to the device. Data would also be recorded and stored electronically to allow review of the sequence of events at a later time. Furthermore, data could include video images of interest such as the patient, the patient in the CR, etc. In summary, the CR incorporates one or more functions that are performed by one or multiple people during ACLS resuscitation or a code. Preferably a fully-functional CR would combine and integrate all aspects of American College of Cardiology (ACC) or American heart guidelines for resuscitation. The CR differs from current units used for cardiac arrest resuscitation in that it combines a CPR plunger, a defibrillator and pacemaker, a fluid delivering device, a fluid extraction device as well as multiple sensors, into one device that is automated and chiefly operated by a computer sequence. The CR could perform blood draw measurement and analysis of electrolytes, blood gas, oxygen saturation, CO2 saturation, body temperature, etc. The CR would be able to deliver IV fluid which may be hypothermic or normal temperature. It would be able to deliver medications and solutions as indicated by ACC and American Heart Association guidelines. Furthermore, the CR would be able to deliver IV fluids by performing an intraosseous injection either in the sternum or with a robotic arm into the intraosseous portion of the knee. The CR could also provide injections into other parts of the body. The CR would also link to 911, EMS, local emergency rooms or hospitals. It would also incorporate an individual patient's advance directives into treatment algorithms and follow the patient's wishes. In another implementation the CR incorporates one or more of the features of a CIU, permitting multimodal biometrics such as a camera for visual recognition, fingerprint sensor, etc. enabling identification of the patient and accessing appropriate advance directives and medical files. The CR can access a patient's PDCS if it is available.

n another modification of the robot, the CR might over ventilation during a code, a tube might originate from the robot which can deliver a tidal volume of air for ventilation. This tidal volume might be room air, or it could be supplemented with oxygen. An oxygen tank might be contained inside the robot, or supplementary oxygen from an outside source can be hooked into the robot. In order to generate the tidal volume, the robot might compress an Ambu bag, use a piston or billow type system. A standard tidal volume for an adult may be the default setting. (Eg—500 cc) The ability to vary this output however would be available to a bystander or medical personnel. A default rate of ventilations, for example 12, might also be something that could be varied by medical personnel. The tubing coming from the robot would be the standard caliber used in order to be able to hook up to a facemask, King laryngeal tube, an endotracheal tube, etc. The code robot could contain within its unit, the standard size endotracheal tubes, King tubes, and facemasks. In another variation, the robot might have a robotic arm which could perform the intubation or tracheostomy.

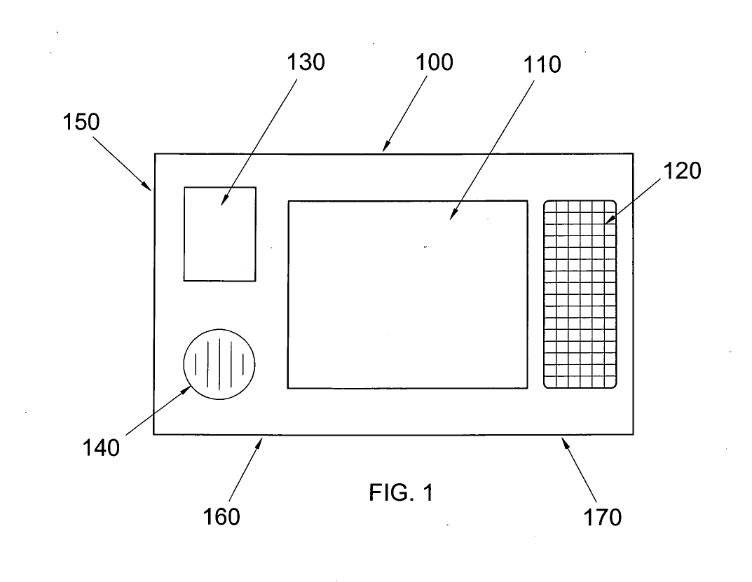

FIG. 1 illustrates a front view of the combined identification unit CIU (100). A high resolution viewing screen (110) is used to display printed text (e.g., patient name, history, treatment wishes) as well as high resolution pictures/photographs for identification purposes. A keyboard/keypad (120) can be used to enter in information manually. A touch pad (130) is available for obtaining fingerprints, vein scans, etc. A speaker/microphone (140) is present for audio applications such as to accept voice command and verbal instructions, provide audio instructions, record audio, etc. An optional camera (not shown) can be included for verification purposes and for video communications. An access port (150) permits a cable connection (e.g., USB) to be used to communicate directly to an external computer (laptop, tablet, etc.) or device such as a CR. Power cord plug (160) permits the CIU to run on external power or charge an internal battery. Docking port (170) allows the CIU to be mounted within a cradle on top of a CR or separate from a CR. The unit includes WIFI capabilities as well as access to a wired connection. These capabilities would allow for communication with the information workstation or, if needed, to the local, regional or national (or international) network and appropriate databases. Optionally a biometric scanner can be included for purposes of fingerprinting or other types of biometric identification. The display screen (such as an LCD display or other display technology) can optionally possess touch screen capabilities for selecting input and acquisition options. Virtual keyboard technology can be implemented. A separate touch pad can be featured. A speaker and microphone are present to broadcast/receive verbal information, voice commands, and allow for voice recognition. A camera can be included permitting facial recognition and profiling. A recessed plug-in receptacle for a power cord is present. This plug-in receptacle could also be compatible with a charging station or dock to charge the battery.

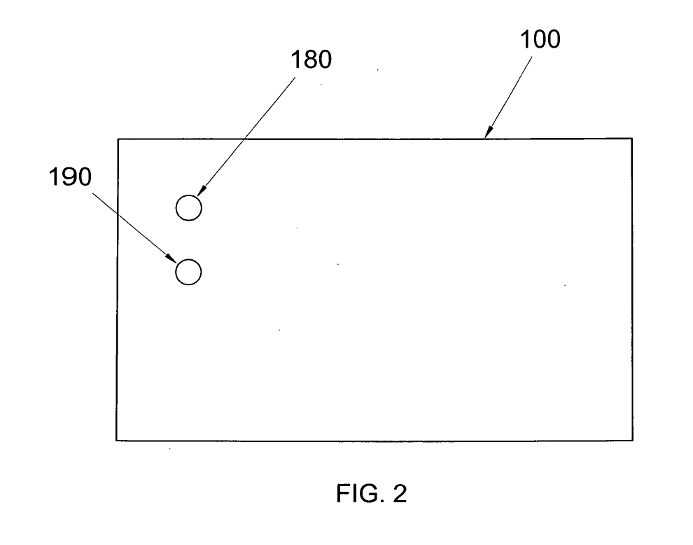

FIG. 2 illustrates a view of the back side of the CIU. Camera (180) permits patient photographs to be taken for facial identification, retinal scanning, bar code scanning, etc. Optionally, it can be used to record a video record (a microphone can be included with camera as needed). A LED light/flash (190) provides illumination for low light situations and photo taking. The CIU, as previously described, can contain one or more antennas enabling WIFI capabilities as well as wireless communication with devices such a CR and computers (access servers/data bases, laptops, tablets, cell phones, etc.). In addition, the antenna can be used to read RFID chips.

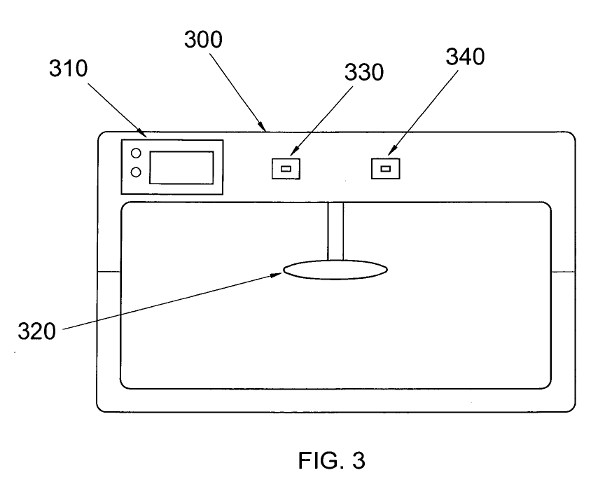

FIG. 3 illustrates an end-on view of a CR (300). A display screen (310) can display real time ECG, oxygen saturation, blood pressure, end tidal CO₂ or other vital monitoring information. An adjustable-height, motorized plunger (320), also referred to as the CPR plunger, is used to perform chest compressions. Outlets for replaceable single-use items include IV tubing outlets (330) and defibrillator pad outlets (340).

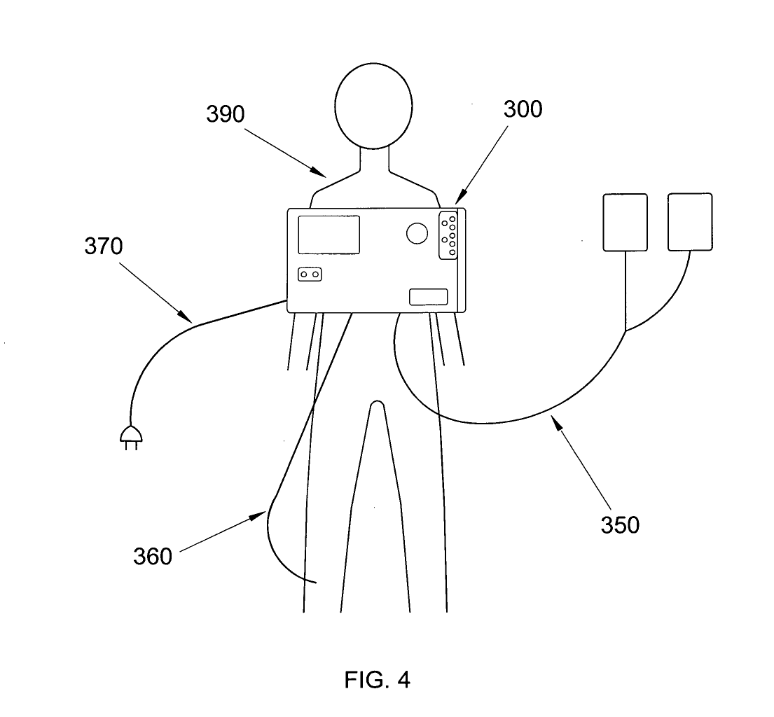

FIG. 4 illustrates a top view of the CR (300) in place on a patient (390). A power supply cord is present (370) but a replaceable/rechargeable power pack can also be relied on for extended periods if an AC power source is unavailable. Intravenous or intraosseous tubing (360) is connected to CR outlets so that the CR can automatically deliver drugs and medicines as is appropriate. Replaceable defibrillation pads (350) are connected to the CR outlets and controlled by the CR as is appropriate.

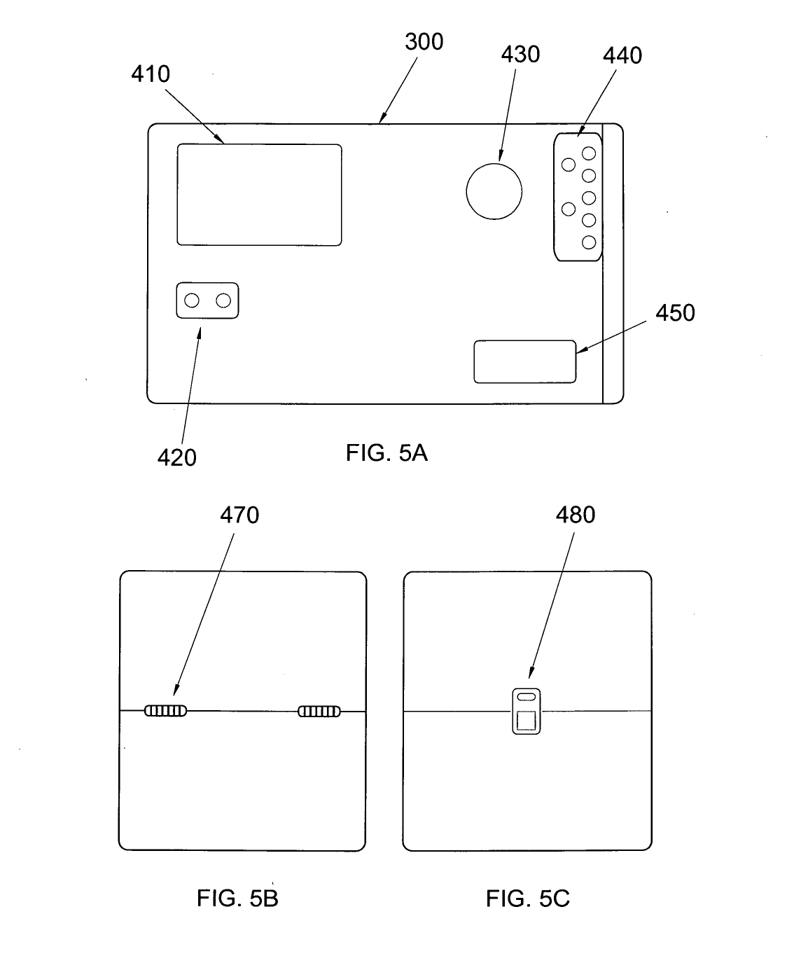

FIG. 5A illustrates a top view of the CR (300). An access panel (410) opens to allow access to segregated components such as a power pack/battery, a holder for single use drug vials/ampules, etc. A cradle (420) for advance directives device such as a CUI, a cell phone, a tablet, etc. is present wherein the device can be placed to coordinate with the CR and insure actions performed by the CR are consistent with the patient's treatment wishes. This communication can also be performed via wireless or wired connections without the device having to be in the cradle. One or more control panels (440) and adjustable control dials (430) allow providers to override actions being performed by the CR in instances where it is deemed appropriate and to quickly adjust settings (optionally, the functions of the dials can be incorporated into the control panel). A remote control device (450) is held in a separate cradle and can be removed by providers to again override the CR if deemed appropriate while standing at a distance from the CR.

FIG. 5B illustrates a side view of the CR showing hinges (470) enabling the top cover to swing open and simplifying access for the patient.

FIG. 5C illustrates a side view of the CR (opposite the side shown in FIG. 5B) showing a clasping apparatus (480) enabling the top cover of the CR to remain securely closed over the patient.

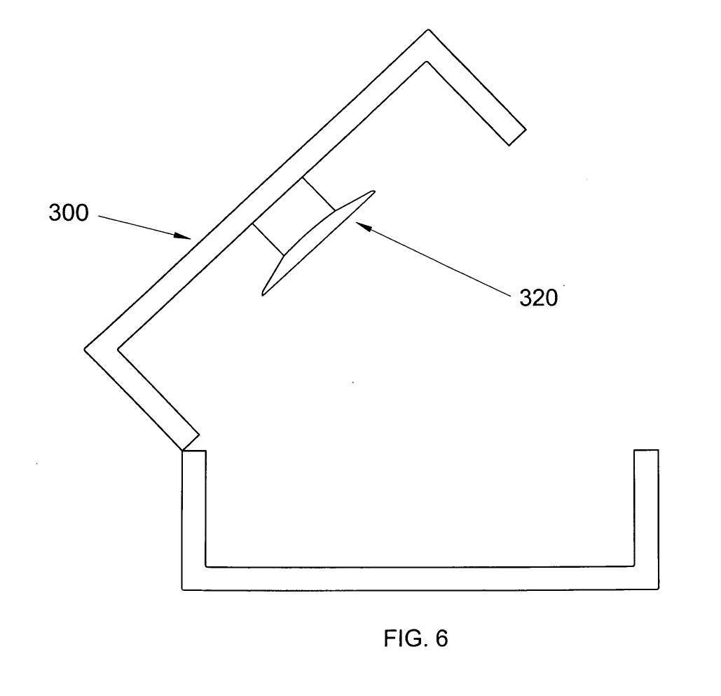

FIG. 6 illustrates the CR (300) in the opened position with its adjustable-height, motorized chest compression plunger (320) which allows for the CR to be more easily and rapidly applied to a patient.

Emergency medical personnel, first responders, health care providers, paramedics, fire fighters, etc. would make use of this system to individualize the medical care provided at emergencies to fit the wishes of any particular patient. In this way, the care provided would be tailored to the patient's medical situation taking into account their prior medical problems, allergies, currently used medications, resuscitation wishes, etc. Health care personnel would be registered into the system at the health care facility where they work. As with patient enrollment, health care personnel (users) would be registered using at least one technique including, but not limited to: 1. Face recognition and profiling. 2. Other biometrics such as finger, hand, palm, arm, retina, vein patterns, sub-dermal, EKG, etc. 3. Voice recognition. 4. Identification using RFID badges or chip implants (including implants such as pace makers, loop recorders, etc.) with information retrieval capabilities. 5. Identification using wearable devices such as smart phones/iphones, iwatches, Google glasses, clothing, bracelets, etc. with information retrieval capability. In addition, health care personnel can be given a personal ID and password for logging in.

Identification application software that can run on a variety of hardware would allow identification of patients and health care personnel. For example, automated code sequences and monitoring could be implemented (how many times to attempt a given procedure, what not to attempt, etc.). For example, identification application software could be linked to (via the CUI or other means) or run directly on the CR. This CR would be able to perform one or more of the following options: heart rhythm monitoring, temperature monitoring, blood pressure monitoring, defibrillation and pacing, automated IV or IO medication administration or chilled saline administration, chest compressions, etc. BP, temperature, HR, ECG, O₂ saturation, blood gas, electrolyte monitors might be incorporated in to this CR. All functions performed by the CR would be stored in its memory log and could easily be accessed at a later time by health care personnel to review the events of code. The actions taken by the machine could also be transmitted in real time to remote locations (e.g., local EMS) to assist in patient care. Application of the CR to a patient would be facilitated by visual diagrams demonstrating proper application as well as potentially audio instructions, video instructions or projected holographic videos. The CR would be linked to the advance directives system allowing any specific patient wishes to be automatically incorporated into the code algorithms. EMS personnel would have the ability to override the CR if necessary. At registration, varying levels of authorization could be assigned to individuals on an as-needed basis (e.g., read records only, read and alter records, etc.).

When a unconscious or incapacitated patient arrives in the emergency room, or when first responders arrive at the scene of a medical emergency, medical records or information on the patient being treated are frequently not available. Bystanders may be unfamiliar with the individual. Even family or friends present may not know of the ill person's medical history or wishes, or may be physically or emotionally unable to communicate what they do know. The invention will typically allow near-instantaneous access to this significant information.

The care provider (authorized user) will login to the CIU prior to using it with one of the identification devices listed below. The care provider will then use the identification module to search for the records in the enrolled database. The identification module is powered with a contained, rechargeable battery (or other energy storage device) or can be used with a power adapter cord. Optionally, solar cells can be incorporated into the unit. The care provider holds the identification module and employs one or more of the identification devices to enter the patient's data. Enrolled patients may be identified using at least one of the identification markers previously described including, but not limited to: 1. Face recognition and profiling. 2. Other biometrics such as (including, but not limited to) finger, hand, palm, arm, retina, vein patterns, sub-dermal, EKG, etc. 3. Voice recognition. 4. Identification using RFID badges or chip implants with information retrieval capability. 5. Identification using wearable devices such as iphones, iwatches, Google glasses, clothing, bracelets, other jewelry, ID cards, etc. with information retrieval capability. If a higher level of accuracy or security is required then two or more identification markers must be verified to ensure proper identification. For example, the authorized care provider can quickly take an image of the person by employing the camera function. The image will be transmitted to a server and a database will be searched for a match. If no match is found within the databases assigned to enrollees then (with permission) government and social data bases can be searched. It is possible that the person is wearing a bracelet with an RFID chip or one was incorporated into their insurance card at enrollment. Relatives, friends, etc. may be able to provide the patient's name and thereby potentially shortening the search process. Using one of the potential identifiers, the identification tool will access the information of the ill or incapacitated person. The image taken at enrollment (or an updated image) as well as basic demographic data (name, address, etc.) will be displayed. The authorized user can then verify that the identity is correct (via input, voice command, etc.) and have the patient's medical care folder opened up either on the identification unit itself or on a nearby information workstation. The information screen will display important information relevant for treating the patient in an emergency medical situation. For example: “Mr. Smith requests no CPR be performed.”, “No blood transfusions.”, “Do not intubate.”, “Seizure disorder and diabetes.”, “On warfarin.”. The display screen will also show multiple tabs (typically along the side of the screen) to aid in navigating through the information (current medications, medical conditions, medical recorders, medical tests, allergies, etc.). Opening any given tab could lead to subfolders. As an example, the medical tests folder might have subfolders for ECGs, CT scans, chest x-rays, etc. Electronic medical recorder developers could incorporate automatic transmission of these data to the database for those enrollees who agree. This feature would make any given electronic medical recorder system more attractive, improving care and lowering cost. The system software can be configured to automatically contact specific individuals, employers, etc. from a list of contacts previously provided by the patient once the patient has been identified.

In a setting where the patient is wearing a PDCS, the need for network access can be bypassed in order to have the most rapid access to advance directives, basic medical and demographic data. If the accuracy of the information stored on the PDCS is questioned then verification can be attained by accessing the relevant database server and downloading the up-to-date information to the authorized user. In this case, obtaining data from the PDCS will provide identification and biometric data stored in the PDCS at enrollment (or subsequently updated) that can be compared with data obtained at the scene (photo, fingerprint, etc.) to verify the patient's identity. After verification, the medical information data stored on the PDCS will immediately be available to the care provider on the identification module/information workstation.

In order to facilitate usage of the Advance Directives system, an application for cellular phones (or devices such as iPADs/tablets and laptop computers) can be created to convert a “smart phone” (or devices such as iPADs/tablets and laptop computers) to a portable identification/workstation device using the camera and microphone features (and any scanning features) on the phone to allow facial recognition to be utilized, tags to be read, fingerprints to be obtained, voices to be recorded, etc. In addition, a variety of biometric readers (including EKG recorders), RFID readers, scanners, etc. can be attached to smart phones, iPADs or tablets and laptops to enable these identification features. A desktop application can also be made available so that once a patient is properly identified more than one health care provider, particularly in a hospital, emergency room, or clinic setting, can concurrently utilize computers to access a patient's information, old records and other features to peruse them for essential information as efficiently as possible.

Enrollees in the system may be asked to periodically verify demographic data as well as their advance directives. For example, this could be done annually when they renew their insurance coverage or every two years for Medicare. An updated photo (or other biometric information) can be obtained at this time and consent to the release of records to the database would also be confirmed.

The invention Literature references expressly incorporated by reference: Woerlee, et al., SYSTEM AND METHOD FOR AUTOMATIC CPR, U.S. Patent No. US20110092864 Al [Apr. 21, 2011].

While the invention is susceptible to various modifications and alternative forms, specific examples thereof have been shown by way of example in the drawings and are herein described in detail. It should be understood, however, that the invention is not to be limited to the particular forms or methods disclosed, but to the contrary, the invention is to cover all modifications, equivalents, and alternatives falling within the spirit and scope of the appended claims.

1. An Advance Directives portable combined identification unit system comprising:
at least one biometric or non-biometric identification device,
a display screen,
a keyboard,
a speaker and microphone,
at least one camera,
a docking unit,
a power source,
an electronic communications link to at least one of a computer server, a Personal Data Containment System device for identity verification and access to patient information, an information display workstation.

2. The system of claim 1 wherein biometric identification devices include at least one of a camera for face recognition and profile, a microphone for voice recognition, a finger print or palm print biometric reader, an eye scanner, an infrared imager, a chemical sensor.

3. The system of claim 1 further including at least one non-biometric identification device including a RFID reader, a smart chip reader, an embedded chip reader, a badge reader, a scanner.

4. The system of claim 1 wherein the functions of the portable identification unit are implemented using a fixed or portable electronic device, including but not limited to, a computer tablet, a desktop computer, a laptop computer, a cellular phone, a wearable computer.

5. A Personal Data Containment System device comprising:
a portable, secure data storage unit accessible by physical or wireless means that stores the patient's advance directives and identifying biometric information.

6. The Personal Data Containment System device of claim 5 wherein a data storage unit is one of a RFID-enabled chip, a smart chip, an embedded chip, a flash drive, a bar code, a tag, a smart phone application, a tablet device application.

7. The Personal Data Containment System device of claim 5 wherein the data storage unit includes information about the patient's medical history and relevant personal information.

8. An automated code robot device comprising:
an adjustable-height, motorized plunger,
at least one patient monitoring devices including, but not limited to, an end tidal CO₂ monitor, an oxygen saturation monitor, an automatic blood pressure cuff, an electrolyte and blood chemical monitor, a heart monitor, a gas monitor,
a defibrillator and pacemaker device,
a fluid delivering device,
a fluid extraction device
outlets for replaceable items including, but not limited to, IV tubing and defibrillator pads,
a robotic arm for drilling, acquiring samples, administering fluids and drugs,
a docking port for mounting an advance directive combined identification unit,
a display,
a speaker and microphone,
at least one camera,
a biometric reader,
a control panel, dials and an access panel for on-site medical personnel to operate or override the code robot,
computer algorithms that implement advance cardiac life support protocol measures per current American Heart Association or American College of Cardiology guidelines including patient data collected by code robot sensors, data input from medical personnel, personalized advance directives of each patient.

9. The code robot of claim 8 wherein the code robot can communicate with at least one of a portable combined identification unit or equivalent electronic device, an advance directives data base, a code station, hospital, paramedic or emergency medical systems station.

10. The code robot of claim 8 wherein the code robot includes at least one ultrasound imaging device.

11. An Advance Directives application implemented on a fixed or portable computer device, wherein the application enables the user of the computer device to activate and contact the Emergency Medical System and 911 either for the user or another individual and thereby facilitating an expedited process of identifying a patient in the field and treating the patient using a level of care consistent with the patient's wishes.

12. The portable computer device of claim 11, wherein the portable computer device is comprised of at least one of a personal digital assistant, a cell phone, a smart phone, a smart watch, an iwatch, smart bracelet, smart glasses, an RFID, a smart chip, an embedded chip.

13. The Advance Directive application of claim 11, wherein the application enables the user to acquire and transmit at least one of 3-D facial identification information, body recognition identification information, biometric identification information, electronic identification information, non-secured identification information.

14. The Advance Directive application of claim 11, wherein the application enables at least one of interactive communication with the Emergency Medical System, direct interaction with the application itself regarding best medical care for the patient by the user and bystanders.

15. The Advance Directive application of claim 11, wherein the application enables communication with at least one of a monitoring device, an interventional device with monitoring capability, a therapeutic device with monitoring capability.

16. A method for enhancing availability of Advance Directives and relevant health information to authorized users by securely storing the information on at least one of a local computer device, a central database.

17. A database system which stores personalized emergency care plans and wishes of individual enrollees in a manner that allows retrieval of said information based on precise patient identification by EMS personnel in real time when emergency care is being provided.
